(19) United States
(12) Patent Application Publication
(10) Pub. No.: US 2026/0154721 A1
(43) Pub. Date: Jun. 4, 2026

(54) AUTOMATICALLY CREATING AN INVENTORY FOR BUSINESS APPLICATION TECHNOLOGY

(71) Applicant: AT&T Intellectual Property I, L.P., Atlanta, GA (US)

(72) Inventors: Barrett Kreiner, Woodstock, GA (US); Harsh Patel, Marietta, GA (US); Jaime Amezaga, Allen, TX (US)

(21) Appl. No.: 18/967,624

(22) Filed: Dec. 3, 2024

(51) Int. Cl. G06Q 30/0601; G06F 8/71

(52) U.S. Cl. CPC G06Q 30/0621; G06F 8/71

(57) ABSTRACT

A method includes obtaining a plurality of tuples, each tuple containing information about a different software title installed on a computing system of an enterprise, matching a first subset of the tuples to respective entries in a technology catalog, identifying a second subset of the tuples for which exact matches cannot be found in the technology catalog, applying a plurality of matching rules to each tuple of the second subset, wherein each matching rule generates a variation of the each tuple of the second subset and produces as an output comprising: at least one entry in the technology catalog that most closely matches the variation and a confidence in a match of the at least one entry to the each tuple of the second subset, and annotating the result of the business application discovery process with a result of the matching and the applying of the plurality of matching rules.

The present disclosure relates generally to business applications and software and relates more particularly to devices, non-transitory computer-readable media, and methods for automatically creating an inventory for business application technology.

### BACKGROUND

Enterprise computing systems often utilize various business applications in the form of software packages installed on computing devices such as servers or operating systems (e.g., virtual machines, physical hardware, dedicated devices, cloud systems, or the like). Various tools exist to examine a computing system and perform an inventory of the software packages installed on the computing system. The process of performing this inventory may also be called discovery. The result of the discovery is, for a given computing system, a list of software titles installed on the computing system. Each software title may be listed as a tuple of vendor, product, and version, or, for products that include multiple editions, as tuples of vendor, product, version, and edition.

### SUMMARY

Devices, non-transitory computer-readable media, and methods for automatically creating an inventory for business application technology are disclosed. An example method includes obtaining, from a discovery tool, a result of a business application discovery process, where the result comprises a plurality of tuples, and wherein each tuple of the plurality of tuples contains information about a different software title installed on a computing system of an enterprise, matching a first subset of the plurality of tuples to respective entries in a technology catalog associated with the computing system of the enterprise, identifying a second subset of the plurality of tuples for which exact matches cannot be found in the technology catalog, applying a plurality of matching rules to each tuple of the second subset, wherein each matching rule of the plurality of matching rules generates a respective variation of the each tuple of the second subset and produces as an output comprising: at least one entry in the technology catalog that most closely matches the respective variation and a confidence in a match of the at least one entry to the each tuple of the second subset, and annotating the result of the business application discovery process with at least one result of the matching and the applying of the plurality of matching rules.

In another example, a non-transitory computer-readable medium stores instructions which, when executed by a processing system including at least one processor, cause the processing system to perform operations. The operations include obtaining, from a discovery tool, a result of a business application discovery process, where the result comprises a plurality of tuples, and wherein each tuple of the plurality of tuples contains information about a different software title installed on a computing system of an enterprise, matching a first subset of the plurality of tuples to respective entries in a technology catalog associated with the computing system of the enterprise, identifying a second subset of the plurality of tuples for which exact matches cannot be found in the technology catalog, applying a plurality of matching rules to each tuple of the second subset, wherein each matching rule of the plurality of matching rules generates a respective variation of the each tuple of the second subset and produces as an output comprising: at least one entry in the technology catalog that most closely matches the respective variation and a confidence in a match of the at least one entry to the each tuple of the second subset, and annotating the result of the business application discovery process with at least one result of the matching and the applying of the plurality of matching rules.

In another example, a device includes a processing system including at least one processor and a non-transitory computer-readable medium. The non-transitory computer-readable medium stores instructions which, when executed by the processing system, cause the processing system to perform operations. The operations include obtaining, from a discovery tool, a result of a business application discovery process, where the result comprises a plurality of tuples, and wherein each tuple of the plurality of tuples contains information about a different software title installed on a computing system of an enterprise, matching a first subset of the plurality of tuples to respective entries in a technology catalog associated with the computing system of the enterprise, identifying a second subset of the plurality of tuples for which exact matches cannot be found in the technology catalog, applying a plurality of matching rules to each tuple of the second subset, wherein each matching rule of the plurality of matching rules generates a respective variation of the each tuple of the second subset and produces as an output comprising: at least one entry in the technology catalog that most closely matches the respective variation and a confidence in a match of the at least one entry to the each tuple of the second subset, and annotating the result of the business application discovery process with at least one result of the matching and the applying of the plurality of matching rules.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for automatically creating an inventory for business application technology may operate;

FIG. 2 illustrates a flowchart of an example method for automatically creating an inventory for business application technology, in accordance with the present disclosure;

FIG. 3 illustrates an example set of synthetic records that may be generated according to the method of FIG. 2; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for automatically creating an inventory for business application technology. As discussed above, enterprise computing systems often utilize various business applications in the form of software packages installed on computing devices such as servers or operating systems (e.g., virtual machines, physical hardware, dedicated devices, cloud systems, or the like). Various tools exist to examine a computing system and perform an inventory of the software packages installed on the computing system. The process of performing this inventory may also be called discovery. The result of the discovery is, for a given computing system, a list of software titles installed on the computing system. Each software title may be listed as a tuple of vendor, product, and version, or, for products that include multiple editions, as tuples of vendor, product, version, and edition.

The result of the discovery process (i.e., the list of software titles defined as tuples) may be matched to entries in a technology catalog. Each entry in the technology catalog may include a tuple similar to the tuples generated by the discovery tool. Each entry in the technology catalog may additionally list a plurality of attributes for the corresponding software title. These attributes may include vendor-specified attributes, such as: date of first release, date on which vendor support (or free vendor support) will no longer be available, common vulnerabilities and exposures (CVEs), and the like. A given enterprise may also assign one or more internal or proprietary attributes to a software title, such as: whether the enterprise prefers to avoid or encourage use of the software title, plans to discontinue use of, replace, or upgrade the software title, and the like.

Matching a software title generated by a discovery tool to an entry in a technology catalog is not always a straightforward process. For instance, the vendor for a given software title may change between the time that the software title is installed and the time that discovery is performed (e.g., due to sale of the software title from one vendor to another, renaming of the vendor, or the like). In this case, there may not be an exact match in the technology catalog for a given discovery result (e.g., tuple). For example, while a tuple may be found in the technology catalog that matches the product, version, and edition portions of the tuple produced by the discovery tool, the vendor portions of the tuples may not match. Thus, depending on how recently the tools used to perform the discovery have been updated, some of the results of the discovery may be difficult to match to a technology catalog.

Examples of the present disclosure automatically create an inventory for business application technology by compiling information from various data sources, such that a list of all detected technologies for a given business application is created from all of the software found on all of the associated servers. In one example, a plurality of technology matching rules attempt to match a business application discovery result to a closest matching entry in a technology catalog when an exact match for the business application discovery result is not found. The technology matching rules may rely on variations which may be modeled after human intuitive perceptions of similarity.

In one example, each matching rule may generate an output that identifies a closest matching entry in the technology catalog. The output may be annotated with metadata to indicate a strength of the match (e.g., a confidence score, where a confidence score of zero indicates a low likelihood of match and a confidence score of 100 may indicate an exact match). The strength of the match may be based, at least in part, on the number of variations or changes made to a corresponding discovery result before a closest matching entry can be identified.

Thus, examples of the present disclosure may allow an enterprise to derive insights from its business application and technology portfolio in a much more efficient manner than would be possible if attempted manually. The derived insight may allow the enterprise to make more informed decisions regarding usage (or lack of usage) of business applications and other products, availability of support for software, impacts of changes in technology standards, and the like. This knowledge, in turn, may allow the enterprise to optimize contract costs with vendors. For instance, an example large enterprise may have approximately 8,000 business applications, 1.3 million servers, 0.5 million application-to-server associations, 66 million inventory records for the servers, and 20,000 technology catalog records. It would be practically infeasible to analyze this data manually.

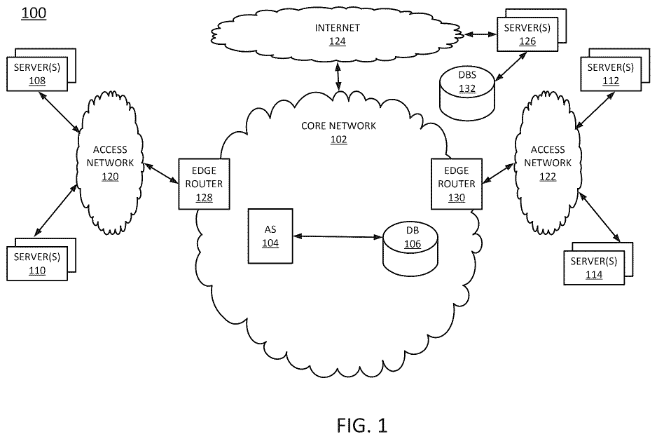

In further examples, the present disclosure may allow invalid server information to be detected (e.g., by identifying the invalid information associated with a computer model, virtual machine, or the like) and corrected (e.g., by applying a tabular or algorithmic correction). When the source system is updated with the correct information, the correction may “go quiet” (e.g., no longer be applied), so that any issues related to a match to the source system can be referred back to the source system for correction. The resultant data set that is created may allow an enterprise to detect, for example, all business applications that utilize a given product and to determine whether consumption of the product is ongoing. These and other aspects of the present disclosure are discussed in greater detail below in connection with the examples of FIGS. 1-4.

To further aid in understanding the present disclosure, FIG. 1 illustrates an example system 100 in which examples of the present disclosure for automatically creating an inventory for business application technology may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VOIP) networks, Service over IP (SoIP) networks, the World Wide Web, and the like.

In one example, the system 100 may comprise a core network 102. The core network 102 may be in communication with one or more access networks, such as access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network and the like), a cellular access network, a 3^{rd} party network, and the like. For example, the operator of the core network 102 may provide a cable television service, an IPTV service, media streaming service, or any other types of communication services to subscribers via access network 120 or access network 122. In one example, the core network 102 may be operated by a telecommunication network service provider. The core network 102 and the access networks 120 and 122 may be operated by different service providers, the same service provider or a combination thereof, or the access networks 120 and 122 may be operated by an entity having a core business that is not related to telecommunications services, e.g., corporate, governmental, or educational institution LANs, and the like.

In one example, the access network 120 may be in communication with servers 108 and 110 at one or more enterprise locations. The access network 120 may transmit and receive communications between the servers 108 and 110, between the servers 108 and 110 and the server(s) 126, the AS 104, other components of the core network 102, devices reachable via the Internet in general, and so forth. Similarly, the access network 122 may be in communication with servers 112 and 114 of one or more enterprise locations. The access network 122 may transmit and receive communications between the servers 112 and 114, between the servers 112 and 114 and the server(s) 126, the AS 104, other components of the core network 102, devices reachable via the Internet in general, and so forth.

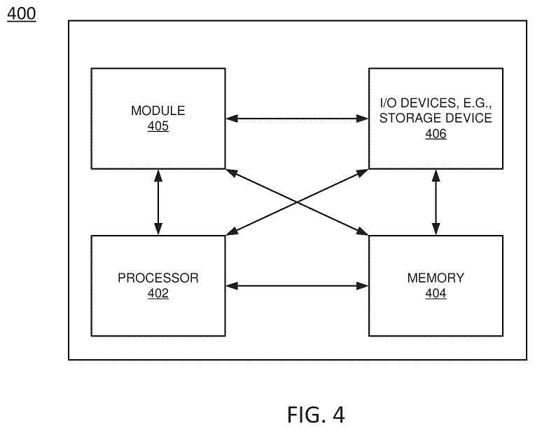

In one example, each enterprise location connected to the system 100 may include a plurality of servers 108, 110, 112, or 114 that support a plurality of business applications. The servers 108, 110, 112, or 114 may each comprise physical hardware servers or operating systems, virtual machines, dedicated devices, cloud systems, or a combination thereof. To this end, any one or more of the servers 108, 110, 112, or 114 may comprise one or more physical devices, e.g., one or more computing systems or servers, such as computing system 400 depicted in FIG. 4, and may be configured as described below. Each of the servers 108, 110, 112, or 114 may have one or more software packages installed thereon and may provide access to resources (e.g., hosts, cores, central processing units, and/or the like) for supporting execution of the software packages to support various operations of the respective enterprises.

In one example, one or more remote servers 126 may be accessible to the servers 108, 110, 112, or 114 via the Internet 124 in general. In one example, the server(s) 126 may operate in a manner similar to the servers 108, 110, 112, or 114 or may provide additional resources and/or data to support the business applications. In another example, the server(s) 126 may operate in a manner similar to the AS 104, which is described in further detail below. In one example, DBs 132 may be accessible by the server(s) 126 and/or by the AS 104.

In accordance with the present disclosure, the AS 104 and DB 106 may be configured to provide one or more operations or functions in connection with examples of the present disclosure for automatically creating an inventory for business application technology, as described herein. For instance, the AS 104 and DB 106 may support discovery tools that interact with servers 108, 110, 112, and 114 to identify any software packages installed on the servers 108, 110, 112, and 114. The AS 104 may generate a list of software titles discovered through this process, where each software title may be listed as a tuple of identifying information (e.g., <vendor, product, version> or <vendor, product, version, edition>).

Once the list of software titles has been generated, the AS 104 may attempt to match the tuples identifying each software title with tuples in a technology catalog, which may be stored by the DB 106. The DB 106 may store a separate technology catalog for each enterprise (e.g., for each set of servers 108, 110, 112, or 114). Each technology catalog may include a plurality of entries. Each entry in the technology catalog may correspond to a software title identified by a tuple (e.g., also in the form of <vendor, product, version> or <vendor, product, version, edition>). Each entry in the technology catalog may additionally list a plurality of attributes for the corresponding software title. These attributes may include vendor-specified attributes, such as: date of first release, date on which vendor support (or free vendor support) will no longer be available, common vulnerabilities and exposures (CVEs), and the like. An enterprise may also assign one or more internal or proprietary attributes to a software title, such as: whether the enterprise prefers to avoid or encourage use of the software title, plans to discontinue use of, replace, or upgrade the software title, and the like.

For each enterprise, the AS 104 may attempt to match software titles from the list generated through discovery to software titles with stored entries in the technology catalog. Sometimes, a tuple from the discovery list will exactly match a tuple in the technology catalog (i.e., all of the values for vendor, product, and version or vendor, product, version, and edition are identical between the tuples). However, there may also be times where an exact match may not be found in the technology catalog. When an exact match in the technology catalog cannot be found, the AS 104 may apply one or more matching rules to attempt to find a closest match. The matching rules may comprise predefined rules that generate variations of the tuples generated through discovery. The variations may include allowing for differences in certain fields of the tuple (e.g., vendor, product, and version must be identical, but edition may not have to be identical). In one example, any match that is found in the technology catalog after applying a matching rule may be associated with a confidence (e.g., a confidence value, a confidence level, a confidence measure, and the like) that indicates a strength of the match. In one example, the confidence may be inversely proportional to the number of variations made to the tuple. In other words, the fewer the number of variations that are made to the tuple, the stronger the match (and the greater the confidence). Conversely, the greater the number of variations that are made to the tuple, the weaker the match (and the lower the confidence).

In one example, once the AS 104 has attempted to match all of the tuples in the list generated through discovery to an entry in the technology catalog, the AS 104 may update the list of software titles generated through discovery with the results of the matching attempts. For instance, for each software title listed, the AS 104 may annotate the list to indicate whether a match was found or not found. For matches that were found, the annotations may further indicate whether the match was an exact match or a closest match found by applying a matching rule, which matching rule was applied to find the closest match if the match was not an exact match, and a relative confidence associated with the match.

In further examples, where multiple possible matches to a tuple in the list generated through discovery are found, the AS 104 may merge the data contained in the multiple possible matches to generate a single synthetic record for the software title identified by the tuple. The synthetic record may include many of the same types of fields of data contained in the technology catalog (e.g., vendor- and/or enterprise-defined attributes for the software title).

The resultant synthetic record may allow a member of the enterprise to easily identify all products (e.g., software titles) associated with a specific business application used by the enterprise, all business applications used by the enterprise that use a specific product, and other information about the computing system and its business applications. In a further example, additional technology information can be incorporated into the synthetic record, such as hardware models of physical devices (which may also have entries in the technology catalog), information not discoverable by a server (such as assisted acquisition services), software bills of materials gathered from code scans, and other information.

To this end, the AS 104 may comprise one or more physical devices, e.g., one or more computing systems or servers, such as computing system 400 depicted in FIG. 4, and may be configured as described below. As discussed above, the AS 104 may have access to at least one database (DB) 106, where the DB 106 may store technology catalogs for different enterprises associated with the servers 108, 110, 112, and 114. The DB 106 may also store synthetic records generated by the AS 104 as described above.

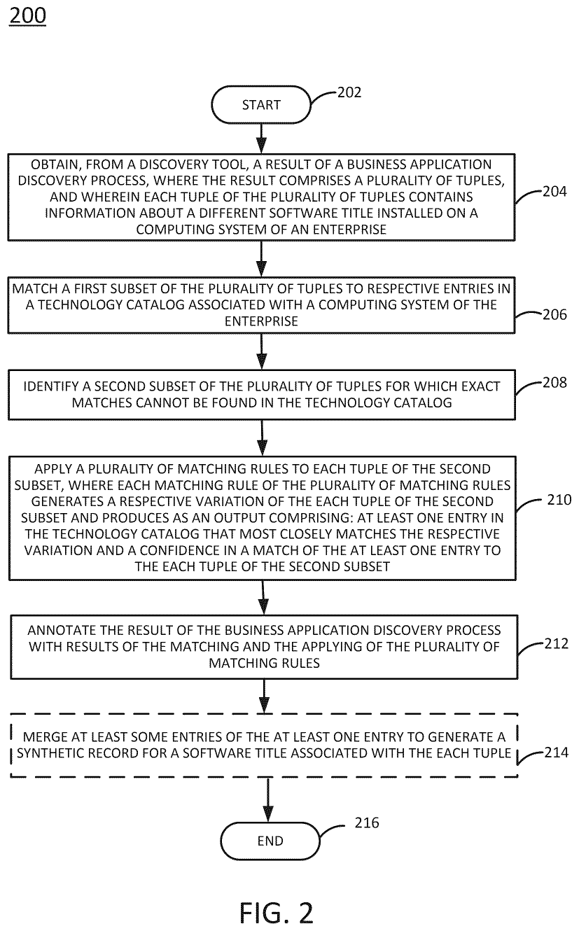

In one example, DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for automatically creating an inventory for business application technology, as described herein. One example method for automatically creating an inventory for business application technology is described in greater detail below in connection with FIG. 2.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, media streaming server, a content distribution network (CDN) and the like. For example, portions of the core network 102, access networks 120 and 122, and/or Internet 124 may comprise a content distribution network (CDN) having ingest servers, edge servers, and the like. Similarly, although only two access networks 120 and 122 are shown, in other examples, the access networks 120 and 122 may comprise a plurality of different access networks that may interface with the core network 102 independently or in a chained manner. For example, user endpoint devices 108-114 may communicate with the core network 102 via different access networks. Thus, these and other modifications are all contemplated within the scope of the present disclosure.

FIG. 2 illustrates a flowchart of an example method 200 for automatically creating an inventory for business application technology, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 200 is described in greater detail below in connection with an example performed by a processing system, such as processing system 402.

The method 200 begins in step 202 and proceeds to step 204. In step 204, the processing system may obtain, from a discovery tool, a result of a business application discovery process, where the result comprises a plurality of tuples, and wherein each tuple of the plurality of tuples contains information about a different software title installed on a computing system of an enterprise.

As discussed above, various tools exist to examine an enterprise computing system and perform an inventory of the software packages installed on the computing system. The process of performing this inventory may also be called discovery. The result of discovery is, for a given computing system, a list of software titles (e.g., expressed as tuples) installed on the computing system.

In one example, the information about the software title that is contained in each tuple of the plurality of tuples comprises at least: a vendor of the software title, a product name of the software title, and a version of the software title. Thus, all tuples obtained in step 204 may follow the format: <vendor, product, version>. In another example, the tuple may further contain an edition of the software title. In this case, all tuples obtained in step 204 may follow the format: <vendor, product, version, edition>.

In step 206, the processing system may match a first subset of the plurality of tuples to respective entries in a technology catalog associated with the computing system of the enterprise. For example, each entry in the technology catalog may correspond to a software title and may include a tuple similar to the plurality of tuples generated by the discovery tool (e.g., <vendor, product, version> or <vendor, product, version, edition>). Each entry in the technology catalog may additionally list a plurality of attributes for the corresponding software title. These attributes may include vendor-specified attributes, such as: date of first release, date on which vendor support (or free vendor support) will no longer be available, common vulnerabilities and exposures (CVEs), and the like. A given enterprise may also assign one or more internal or proprietary attributes (or enterprise defined attributes) to a software title, such as: whether the enterprise prefers to avoid or encourage use of the software title, plans to discontinue use of, replace, or upgrade the software title, and the like.

In one example, each tuple in the first subset exactly matches one tuple in the technology catalog. That is, the values for vendor, product, and version (or vendor, product, version, and edition) are identical for the tuple from the first subset and the matching tuple from the technology catalog.

In step 208, the processing system may identify a second subset of the plurality of tuples for which exact matches cannot be found in the technology catalog. In one example, a tuple in the second subset does not have an exact match when there is no tuple from the technology catalog for which all of the values for vendor, product, and version (and edition, where applicable) are identical. For instance, there may be a tuple in the technology catalog whose values for vendor, product, and version match the corresponding values of the tuple in the second subset, but the values for edition may not match.

In step 210, the processing system may apply a plurality of matching rules to each tuple of the second subset, wherein each matching rule of the plurality of matching rules generates a respective variation of the each tuple and produces as an output comprising: at least one entry in the technology catalog that most closely matches the respective variation and a confidence in a match of the at least one entry to the each tuple of the second subset.

In one example, each matching rule comprises a set of rules that modifies the each tuple in a different way to produce a different variation of the each tuple. In one example, each variation applied to the each tuple is modeled after human intuitive processing of similarity. For instance, one matching rule may find a potential match where the vendor is close but not identical (e.g., Company ABC versus Company AB or ABC Company), and the product, version, and edition are identical. Another matching rule may find a potential match where the vendor and product are close but not identical (e.g., SQL Developer versus Develop SQL), and the version and edition are identical. Another matching rule may find a potential match where the version is close but not identical (e.g., version 10 versus version 10.1 or 10.1.1), but the vendor, product, and edition are identical.

Thus, the processing system may be able to find entries in the technology catalog that match variations of a tuple, even if an exact match for the tuple prior to variation was not found. In one example, the confidence in the match may be inversely proportional to the number of variations a matching rule makes to a tuple of the second subset. For instance, if a matching rule that makes one variation to the tuple of the second subset is able to produce a match in the technology catalog, the match may be considered a relatively strong match (and thus be associated with a relatively high confidence). However, if another matching rule makes three variations to the tuple of the second subset to produce a match, the match in this case may be considered a relatively weak match (and thus be associated with a relatively low confidence).

In optional step 212, the processing system may annotate the result of the business application discovery process with results of the matching and the applying of the plurality of matching rules. As discussed above, the result of the business application discovery process may comprise a list of software titles (expressed as tuples) installed on the computing system. In one example, the processing system may annotate this list with information derived from steps 206 and 210. For instance, for each software title listed, the processing system may annotate the list to indicate whether a match was found or not found. For matches that were found, the annotations may further indicate whether the match was an exact match or a closest match found by applying a matching rule, which matching rule was applied to find the closest match if the match was not an exact match, and a relative confidence associated with the match.

In optional step 214 (illustrated in phantom), the processing system may merge at least some entries of the at least one entry to generate a synthetic record for a software title associated with the each tuple. In one example, a synthetic record may resemble a technology catalog entry for a software title (e.g., may contain the same fields), but may be produced by consolidating the information contained in multiple technology catalog entries that were matched to the tuple that the discovery tool generated for the software title. Because multiple matching rules may be applied in step 210, multiple potential matches (with varying degrees of confidence) may be identified. Merging these multiple potential records into a single synthetic record may help to store software title information more efficiently.

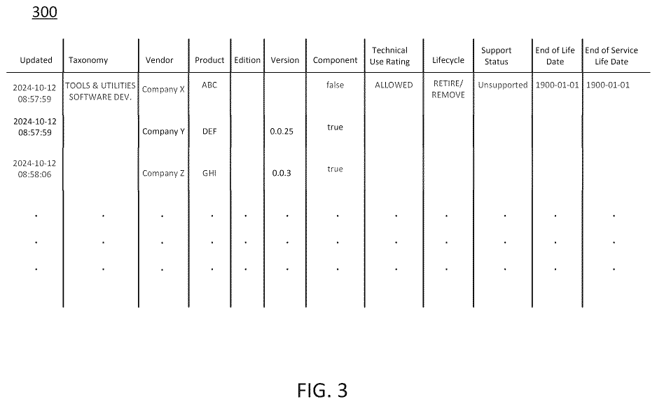

FIG. 3, for instance, illustrates an example set 300 of synthetic records that may be generated according to the method 200 of FIG. 2. As illustrated in FIG. 3, a synthetic record for a software title may comprise a plurality of fields, including fields that identify, for the software title, at least one of: a day (and time) of last update of the software title, a taxonomy of the software title (e.g., tools and utilities—software development, tools and utilities—synchronization, tools and utilities—other, etc.), where the taxonomy may be provided by the technology catalog, a vendor who produces the software title (e.g., as determined by the discovery tool), a product name of the software title (e.g., as determined by the discovery tool), an edition of the software title (e.g., as determined by the discovery tool), a version of the software title (e.g., as determined by the discovery tool), whether the software title is a component of something else, such as an operating system (e.g., a true or false indication), a technical use rating (e.g., an indication of how much the enterprise favors the software title, such as allowed, evaluating, deprecated, or the like), a lifecycle status of the software title (e.g., an indication of whether use of the software title is to be continue or not, such as retire/remove, retire/contain, mainstream, emerging, or the like), a support status of the software title (e.g., an indication of the availability of vendor support, such as unsupported, supported, supportable, or the like), an end of life date, and end of service life date, and/or other fields.

In a further example, a synthetic record for a software title may comprise a plurality of fields in addition to the fields shown in FIG. 3, such as at least one of: total hosts of the computing system consumed by the software title, total central processing units (CPUs) of the computing system consumed by the software title, total cores of the computing system consumed by the software title, caveats (e.g., an indication of the strength of the matches that were merged to create the synthetic record, such as number of matches that were merged), server identifiers of servers of the computing system consumed by the software title, license type associated with the software title (e.g., open source, closed source, commercial, or the like), restrictions on use of the software title, and/or other fields. In a further example, a technology catalog product field may include a hyperlink or pointer that directly links to a catalog entry for the software title.

In one example, if all of entries of the at least one entry contain the same value for a given attribute (e.g., taxonomy, product, vendor, or the like), then the given attribute in the synthetic record will contain that same value. If the entries of the at least one entry include two or more different values, then the given attribute in the synthetic record may specify “multiple” to indicate multiple possible values, or, for certain types of attributes such as dates (e.g., end of life date, end of service life date, date on which support will discontinue, etc.), a most conservative value of the multiple values (e.g., the earliest date) may be entered.

In a further example, generating the synthetic record may further include correcting invalid server information. Invalid server information may be identified by recognizing invalid information associated with an attribute that specifies computer model, virtual machine, or the like and applying a tabular or algorithmic correction to the invalid information.

The resultant synthetic record may allow a member of the enterprise to easily identify all products (e.g., software titles) associated with a specific business application used by the enterprise, all business applications used by the enterprise that use a specific product, and other information about the computing system and its business applications. In a further example, additional technology information can be incorporated into the synthetic record, such as hardware models of physical devices (which may also have entries in the technology catalog), information not discoverable by a server (such as assisted acquisition services), software bills of materials gathered from code scans, and other information. The method may end in step 216.

Thus, examples of the present disclosure may allow an enterprise to derive insights from its business application and technology portfolio in a much more efficient manner than would be possible if attempted manually. The derived insight may allow the enterprise to make more informed decisions regarding usage (or lack of usage) of software titles and other products, availability of support for software, impacts of changes in technology standards, and the like. This knowledge, in turn, may allow the enterprise to optimize contract costs with vendors.

For instance, example insights that might be derived through operation of the method 200 include: the number of distinct hosts, the aggregate CPUs of the distinct hosts, the aggregate core of the servers on which a software product was detected, high-level computing platform information (e.g., on-premises physical devices, on premises virtual machines, public cloud virtual machines, etc.), documented use of detected servers (e.g., development, testing, production, etc.), information from the technology catalog (e.g., technology categorization or taxonomy, internal strategic status of a software product and version, support status, date when extended support is required, data software product is no longer supported, etc.), whether a software product is detected as a component of another product or is a standalone deployment, associations back to a technology inventory product and version (if matched), associations back to the server records of a server on which a software product was detected, list of servers on which a software product was detected or shared with other business applications, product license types and metrics, and/or other insights.

It should be noted that the method 200 may be expanded to include additional steps or may be modified to include additional operations, parameters, or scores with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for automatically creating an inventory for business application technology, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 405 for automatically creating an inventory for business application technology (e.g., a software program comprising computer-executable instructions) can be loaded into memory 404 and executed by hardware processor element 402 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for automatically creating an inventory for business application technology (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
obtaining, by a processing system including at least one processor from a discovery tool, a result of a business application discovery process, where the result comprises a plurality of tuples, and wherein each tuple of the plurality of tuples contains information about a different software title installed on a computing system of an enterprise;
matching, by the processing system, a first subset of the plurality of tuples to respective entries in a technology catalog associated with the computing system of the enterprise;
identifying, by the processing system, a second subset of the plurality of tuples for which exact matches cannot be found in the technology catalog;
applying, by the processing system, a plurality of matching rules to each tuple of the second subset, wherein each matching rule of the plurality of matching rules generates a respective variation of the each tuple of the second subset and produces as an output comprising: at least one entry in the technology catalog that most closely matches the respective variation and a confidence in a match of the at least one entry to the each tuple of the second subset; and
annotating, by the processing system, the result of the business application discovery process with at least one result of the matching and the applying of the plurality of the matching rules.

2. The method of claim 1, wherein the information contained in each tuple of the plurality of tuples comprises at least: a vendor of the different software title, a product name of the different software title, and a version of the different software title.

3. The method of claim 2, wherein the information further comprises an edition of the different software title.

4. The method of claim 1, wherein each entry of the respective entries includes a tuple containing at least some of the information contained in the plurality of tuples obtained from the discovery tool.

5. The method of claim 4, wherein the each entry of the respective entries further includes a plurality of attributes for a corresponding different software title.

6. The method of claim 5, wherein the plurality of attributes includes a plurality of vendor-specified attributes.

7. The method of claim 6, wherein the plurality of vendor-specified attributes comprises at least one of: a date of a first release of the corresponding different software title, a date on which a vendor support for the corresponding different software title will no longer be available, or common vulnerabilities and exposures of the corresponding different software title.

8. The method of claim 5, wherein the plurality of attributes includes a plurality of attributes assigned by the enterprise.

9. The method of claim 8, wherein the plurality of attributes assigned by the enterprise includes at least one of: whether the enterprise prefers to avoid or encourage a use of the corresponding different software title, a plan to discontinue the use of the corresponding different software title, a plan to replace the corresponding different software title, or a plan to upgrade the corresponding different software title.

10. The method of claim 4, wherein the matching comprises determining that values of the tuple contained in the each entry are identical to corresponding values of a tuple of the first subset of the plurality of tuples.

11. The method of claim 1, wherein each matching rule of the plurality of matching rules comprises a set of rules that modifies the each tuple in a different way to produce a different variation of the each tuple.

12. The method of claim 11, wherein the set of rules modifies a value contained in at least one field of the each tuple.

13. The method of claim 12, wherein the confidence in the match is inversely proportional to a number of values contained in fields of the each tuple that are modified to obtain the match.

14. The method of claim 1, further comprising:
merging, by the processing system, at least some entries of the at least one entry to generate a synthetic record for a different software title associated with the each tuple.

15. The method of claim 14, wherein fields of the synthetic record match fields of an entry in the technology catalog for the different software title associated with the each tuple.

16. The method of claim 14, wherein when all entries of the at least some entries contain a same value for a given attribute of the different software title associated with the each tuple, the same value is recorded for the given attribute in the synthetic record.

17. The method of claim 14, wherein when the at least some entries include two or more different values for a given attribute of the different software title associated with the each tuple, a value of multiple is recorded for the given attribute in the synthetic record.

18. The method of claim 14, wherein when the at least some entries include two or more different values for a given attribute of the different software title associated with the each tuple, a most conservative value of the two or more different values is recorded for the given attribute in the synthetic record.

19. A non-transitory computer-readable medium storing instructions which, when executed by a processing system including at least one processor, cause the processing system to perform operations, the operations comprising:
obtaining, from a discovery tool, a result of a business application discovery process, where the result comprises a plurality of tuples, and wherein each tuple of the plurality of tuples contains information about a different software title installed on a computing system of an enterprise;
matching a first subset of the plurality of tuples to respective entries in a technology catalog associated with the computing system of the enterprise;
identifying a second subset of the plurality of tuples for which exact matches cannot be found in the technology catalog;
applying a plurality of matching rules to each tuple of the second subset, wherein each matching rule of the plurality of matching rules generates a respective variation of the each tuple of the second subset and produces as an output comprising: at least one entry in the technology catalog that most closely matches the respective variation and a confidence in a match of the at least one entry to the each tuple of the second subset; and
annotating the result of the business application discovery process with at least one result of the matching and the applying of the plurality of matching rules.

20. A device comprising:
a processing system including at least one processor; and
a non-transitory computer-readable medium storing instructions which, when executed by the processing system, cause the processing system to perform operations, the operations comprising:
obtaining, from a discovery tool, a result of a business application discovery process, where the result comprises a plurality of tuples, and wherein each tuple of the plurality of tuples contains information about a different software title installed on a computing system of an enterprise;
matching a first subset of the plurality of tuples to respective entries in a technology catalog associated with the computing system of the enterprise;
identifying a second subset of the plurality of tuples for which exact matches cannot be found in the technology catalog;
applying a plurality of matching rules to each tuple of the second subset, wherein each matching rule of the plurality of matching rules generates a respective variation of the each tuple of the second subset and produces as an output comprising: at least one entry in the technology catalog that most closely matches the respective variation and a confidence in a match of the at least one entry to the each tuple of the second subset; and
annotating the result of the business application discovery process with at least one result of the matching and the applying of the plurality of matching rules.
